(19) United States
(12) Patent Application Publication
(10) Pub. No.: US 2013/0059291 A1
(43) Pub. Date: Mar. 7, 2013

(54) COMPOSITIONS AND METHODS FOR IDENTIFYING DENGUE VIRUS

(71) Applicants: Richard J. Kuhn, West Lafayette, IN (US); Catherine Paige Riley, Couer d'alene, ID (US); Charles Buck, Coeur d'Alene, ID (US)

(72) Inventors: Richard J. Kuhn, West Lafayette, IN (US); Catherine Paige Riley, Couer d'alene, ID (US); Charles Buck, Coeur d'Alene, ID (US)

(73) Assignee: PURDUE RESEARCH FOUNDATION, West Lafayette, IN (US)

(21) Appl. No.: 13/587,087

(22) Filed: Aug. 16, 2012

Related U.S. Application Data
(60) Provisional application No. 61/524,589, filed on Aug. 17, 2011.

(51) Int. Cl. G01N 27/62

(52) U.S. Cl. 435/5

(57) ABSTRACT

The invention generally relates to compositions and methods for identifying dengue virus. In certain embodiments, the invention provides methods for identifying a dengue virus serotype that involve obtaining a sample comprising at least one dengue virus protein; digesting the protein to produce peptides; ionizing the peptides; detecting a parent and associated fragment ion of the peptides; and identifying the serotype based on results of the detecting step.

### RELATED APPLICATION

The present application claims the benefit of and priority to U.S. provisional application Ser. No. 61/524,589, filed Aug. 17, 2011, the content of which is incorporated by reference herein in its entirety.

### GOVERNMENT SUPPORT

This invention was made with Government support under 5R01A1076331 awarded by the National Institutes of Health. The Government has certain rights in this invention.

### FIELD OF THE INVENTION

The invention generally relates to compositions and methods for identifying dengue virus.

### BACKGROUND

Infection with dengue virus is an emerging disease threat with substantial implications for the global population living in the tropics, the southern temperate zone and increasingly in the northern temperate zone. In the context of global climate change, the range of Aedes aegypti, the mosquito vector for this disease, is increasing to more northern latitudes, and therefore the disease is similarly spreading. Dengue virus infects 50-100 million people per year, and has recently been classified as one of the most aggressive re-emerging pathogens worldwide (Morens and Fauci, 2008), making it the most significant arthropod-borne virus in the world.

There are four distinct serotypes of the virus termed dengue 1, 2, 3, and 4, each causing a similar disease that is marked by fever and severe orbital and joint pain, but more serious syndromes, dengue hemorrhagic fever (DHF) or dengue shock syndrome, occur sometimes following dengue infection. Dengue hemorrhagic fever was mostly confined to Southeast Asia until the 1960's, when it also became endemic in Central America and, more recently, in South America. This more severe form of disease, which is life threatening in approximately ˜15% of patients, is believed to be the result of sequential dengue infections of multiple serotypes. Although the mechanism is not precisely understood, a large body of evidence suggests that antibody-dependent enhancement (ADE) might account for a large portion of the DHF cases (Halstead, 1989).

Closely related flaviviruses cause similar disease with symptoms including fever, rash and intense pain. Although specific therapeutic approaches are not available for these infections, it is important to differentiate the source of infection in order to guide treatment and for epidemiological purposes. In addition, specific assays to monitor viremia and infection with each of these viruses will be critical for development and implementation of specific therapeutics and effective vaccines. Both therapeutics and vaccines for these infectious diseases are areas of active development in the biotechnology and pharmaceutical sectors. An endemic presence of dengue will require an efficient diagnostic screen of the blood supply.

The occurrence of multiple cases of locally acquired dengue fever in 2009-10 illustrates the threat in the United States (CDC, 2010). By mid-summer of 2010, dengue was reported in central Florida, as well as in the Keys where the first cases in decades were reported in 2009. Early this year, Paraguay suspended all non-emergency surgical procedures in the midst of a dengue outbreak. The negative impact of the disease, including the stark economic and social consequences, is increasingly manifest in much of the world, particularly in developing countries of Asia, and Central and South America. Dengue outbreaks in Bangladesh in 2000 and 2002 resulted in hospitalization of over ten thousand citizens with more than 150 deaths, according to WHO figures. This situation is mirrored in many countries with the poor and young disproportionately affected. As there is no effective therapeutic or (as yet) vaccine, and there is little hope to gain ground on the disease beyond inherently problematic attempts to control the mosquito vector. This reality will continue to drive efforts to develop effective vaccines. As indicated above, these efforts will require sensitive, specific and affordable tests for the virus.

A recent World Health Organization guidance report describes advantages and disadvantages of current diagnostic procedures for dengue and other flavivirus infections (WHO, 2009). The most common approaches include detection of viral components or monitoring of increased levels of production of protective antibodies. These tests suffer from poor specificity and high variability, particularly with respect to detection of low levels of virus or infection. In some cases multiple samples are required from the patient to obtain a test result. Sensitive and specific polymerase chain reaction (PCR) tests for viral RNA are available but these tests are hindered by the requirement for sophisticated instrumentation and expertise with complex sample preparation and assay protocols. In addition, the RNA based PCR tests require samples to be refrigerated which introduces logistical challenges that add costs in all cases and may preclude the use of the test for many patients in the developing world.

### SUMMARY

Specific assays have been developed for detection of each of three structural proteins from dengue virus. Methods of the invention can distinguish between the prM protein characteristic of immature viral particles and the mature M protein characteristic of infectious particles. Similarly, a specific assay for the structural E protein is in place to enable monitoring of the number of viral particles in a blood sample, the virus load and the serotype. The invention recognizes an important requirement for viral protein processing in flaviviral maturation. The functional viral proteins derive from a common polyprotein. Conventional diagnostics that measure viral RNA (or RNA copied to DNA) are unable to distinguish the protein cleavage products so that these methods do not enable monitoring of the protein or the extent of virion maturation.

The invention further recognizes that Flaviviruses undergo multiple stages of maturation that are relevant for infectivity. The efficacy of a viral particle-containing vaccine may be dramatically dependent on the precise viral component composition of the vaccine preparation. Methods herein allow for precise and quantitative evaluation of viral preparations that can be applied for evaluation of vaccine preparations. The assays are also relevant for differential diagnosis of flaviviral-infected individuals.

The peptide based MRM assays shown herein provide high sensitivity and selectivity for detection of flaviviruses in human biosamples. The tests do not rely on antibodies and therefore are not subject to non-specific detection of epitopes from other viruses. In addition, the assays shown herein are based on detection of viral peptides and are not affected by storage of biosamples at room or elevated temperatures once the proteins are either enzymatically or chemically degraded. Since the methods described herein are not adversely effected by storage temperature, these methods can be readily accomplished cheaply and quickly in reference laboratories.

In certain aspects, the invention provides methods for identifying a dengue virus serotype that involve obtaining a sample comprising at least one dengue virus protein, digesting the protein to produce peptides, ionizing the peptides, detecting a parent and associated fragment ion of the peptides, and identifying the serotype based on results of the detecting step. Methods of the invention may further involve diagnosing a dengue virus related disease based upon the serotype of the dengue virus. In certain embodiments, the protein is an E protein. In particular embodiments, the peptides of the E protein are at least one peptide selected from the group consisting of SEQ ID NOs.: 1-5 and 9-10. The sample may be any biological sample, such as a human tissue or body fluid. In certain embodiments, the body fluid is blood.

Another aspect of the invention provides methods for determining an amount of immature dengue virus particles in a sample that involve obtaining a sample comprising dengue virus particles, determining a ratio of structural proteins to one another, and determining an amount of immature virus in the sample based upon the ratio. Exemplary structural proteins include E, pr, and M. In certain embodiments, determining a ratio involves a mass spectrometry based multiple reaction monitoring assay. Peptides of the E protein that are monitored are SEQ ID NOs. 1-5 and 9-10. Peptides of the pr protein that are monitored are SEQ ID NOs. 6-8. Peptides of the M protein that are monitored are SEQ ID NOs. 11-12.

Another aspect of the invention provides methods for determining an amount of immature dengue virus particles in a sample that involve obtaining a sample comprising dengue virus particles, determining an amount of structural proteins in the sample, comparing the amounts to a standard curve, and determining an amount of immature virus in the sample based upon the comparing step.

Another aspect of the invention provides a composition that includes at least one peptide selected from the group consisting of SEQ ID NOs.: 1-12. Another aspect of the invention provides methods for identifying a dengue virus serotype that involve obtaining a sample comprising at least one dengue virus protein, digesting the protein to produce peptides, conducting an assay to detect presence of any of SEQ ID NOs.: 1-4 in the sample, and identifying the serotype based the detected sequence. In certain embodiments, the assay is a mass spectrometry based multiple reaction monitoring assay.

### BRIEF DESCRIPTION OF THE DRAWINGS

FIG. 1. The transition for 2 E protein peptides from each dengue serotype. The first set of peaks (orange and pink) represent the peptides unique to the two different serotypes. The second set of peaks (blue and green) are from a peptide that is conserved in all 4 dengue serotypes. The assay simultaneously monitored all of these peaks. The sample in A detects the peak unique to serotype 1 (7.2 minutes) and the conserved peak (about 9 minutes). For the sample in panel B only the peak unique to serotype 2 (7.7 minutes) and the conserved peak are seen. Panels C and D demonstrate the standard curve for a MRM detection of unique peptide/transitions from two different dengue proteins. The right most points are equivalent to 600 fmol and the low point is equivalent to 60 amol; r² values are >0.99. These standards demonstrate the range and accuracy of the method.

### DETAILED DESCRIPTION

The invention generally relates to compositions and methods for identifying dengue virus. In certain embodiments, the invention provides a mass spectrometry based multiple reaction monitoring (MRM) multiplex assay to allow monitoring of a number of viral particles in a blood sample and the serotype. The specific and unique peptides, transitions and related assay parameters are given in Example 1 for DENV types 1-4.

In MRM mode, two stages of mass filtering are employed on, for example, triple quadrupole mass spectrometer. In the first stage, an ion of interest (the precursor) is preselected in Q1 and induced to fragment by collisional excitation with a neutral gas in a pressurized collision cell (Q2). In the second stage, instead of obtaining full scan ms/ms where all the possible fragment ions derived from the precursor are mass analyzed in Q3, only a small number of sequence-specific fragment ions (transition ions) are mass analyzed in Q3. This targeted MS analysis using MRM enhances the lower detection limit for peptides by up to 100 fold (as compared to full scan ms/ms analysis) by allowing rapid and continuous monitoring of the specific ions of interest.

MRM methods provide both absolute structural specificity for the analyte and relative or absolute measurement of analyte concentration when stable, isotopically-labeled standards are added to a sample in known quantities. When a synthetic, stable isotope labeled peptide is used as an internal standard, the concentration can be measured by comparing the signals from the exogenous labeled and endogenous unlabeled species. This can be done because they have the same physicochemical properties and differ only by mass. Further description of MRM is provided for example in Anderson et al. (Molecular & Cellular Proteomics 5.4: 573-588, 2006), Addona et al. (Nature Biotechnology 27:633-641, 2009), and Domon et al. (Science 312(5771):212-217, 2006), the content of each of which is incorporated by reference herein in its entirety.

Given the specificity and the sensitivity of the MRM assays, a single amino acid shift can be detected. Therefore, this assay can readily be used to determine the specific dengue serotype of the infection by monitoring multiple ions from the structural E protein; specifically, unique peptides from each of the different serotypes, making it useful for differential diagnosis of flaviviral-infected individuals.

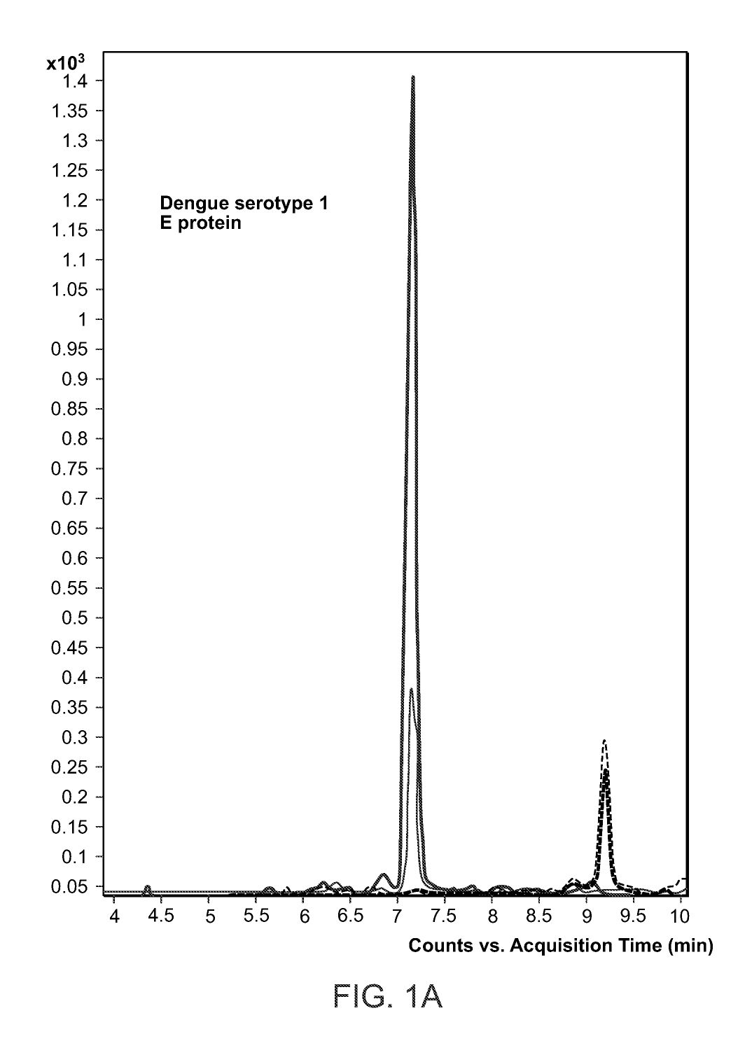

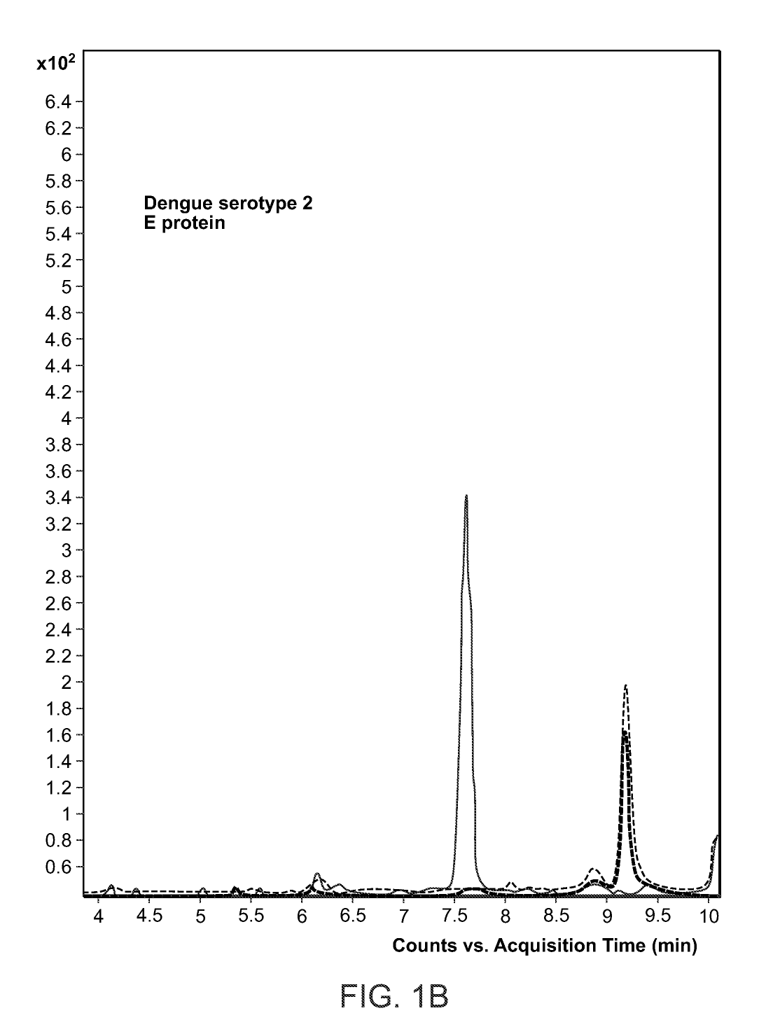

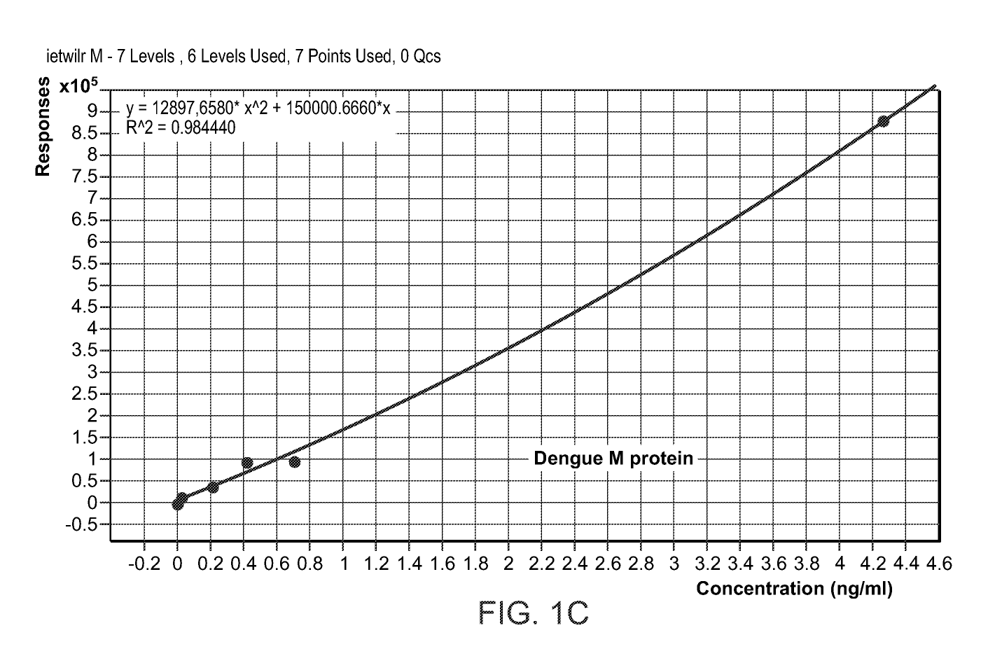

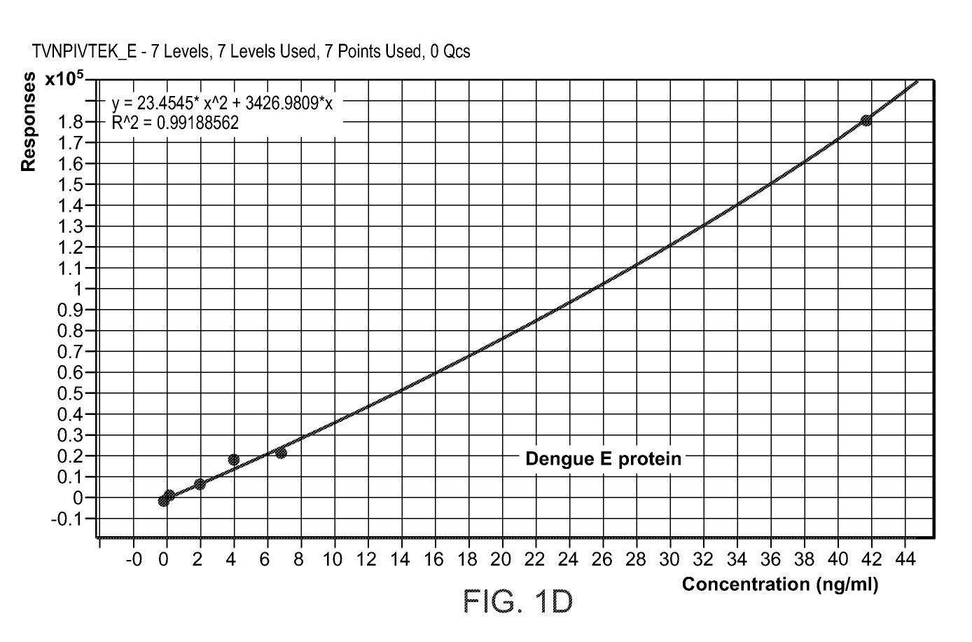

The MRM analysis is done by targeting specific ions in both the first and second mass spectral dimension for unique peptides chosen from each target viral protein. Ions are targeted in two dimensions (MS and MS2) to ensure specificity of the assay. That is, for each specific peptide ion, the assay monitors a parent ion and a specific dissociation fragment, or fragments, of that ion. Each of these molecular species is selected based on the ability to specifically and precisely monitor the retention time and precise mass of the ion. The fragment ions are uniquely created in the mass spectrometer collision cell (via collision induced dissociation) providing chemical certainty with respect to the sequence of the peptide (and therefore the protein target from which it is derived). The detection of parent and fragment ions provides a unique ‘fingerprint’ for the target protein. The approach is represented in FIG. 1, demonstrating specific detection of two dengue serotypes from a cell culture supernatant of cells infected with these viral serotypes.

In certain embodiments, the method involves a sample preparation that includes an acetone precipitation to break down the lipid membrane of the virus, digestion of the protein into peptides with an enzymeor chemical that specifically degrades peptide bonds, followed by mass spectral evaluation. Each monitored ion is optimized for both the fragmentor energy (used to ionize the parent peptide to enrich for monomeric ions to the mass spec) and for collision energies (used to induce fragmentation of the parent ion into specific daughter ions/transitions) to provide high levels of specificity and sensitivity. The data is then analyzed to determine the absolute quantity of the peptides/proteins in the sample based on a standard curve derived from a synthetic peptide of known sequence and concentration evaluated in the relevant matrix (such as plasma).

The specificity and sensitivity of the MRM assays allow detection of a single amino acid difference between peptides. These assays therefore, are readily used to determine the specific dengue serotype of the infection by monitoring multiple ions from viral proteins. In the case of dengue and other flaviviruses, the structural E protein is the ideal target as it is a large abundant virion protein from which suitable peptides for analyses can be identified. E protein also exhibits adequate sequence divergence between flaviviruses to enable development of MRM assays that distinguish different viruses and serotypes. Thus targeting specific E protein peptides will enable differential diagnosis of flaviviral-infected individuals. Unique peptides from the structural E protein of each virus and/or DENV serotype will be chosen for analysis by mass spectrometry. The biochemical composition of the peptides will be evaluated for their ability to readily ionize. Each of these peptides will produce an individual “fingerprint” to distinguish it from the others. The two most prevalent transitions from each of these peptides are monitored in a multiplexed MRM assay. Targeting specific peptides of the E glycoprotein is undertaken to achieve both the differentiation of flavivirus infections and of dengue serotype infections by MRM.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

### EXAMPLES

### Example 1

### Assay Development

The assays were developed by first evaluating a dengue virus 2 recombinant fusion protein of prM and E. The recombinant protein consists mostly of wild type polypeptide E protein and a truncated prM protein. By using the recombinant polypeptide to develop the MRM methods, the sample preparation could easily be evaluated for reproducibility and for the establishment of a standardized standard operation procedure (SOP). Additionally, given that the polypeptide contains equimolar number of each structural protein of interest (E, pr and M) and is not affected by human error, the precise ratio between the structural components could be determined. However, given that the furin cleavage site was altered in this particular fusion protein an additional peptide standard was synthesized to evaluate the peptides associated with the furin cleavage site specifically.

During method development each protein was careful evaluated to determine the appropriate enzymatic protocol. Ideal peptides are 5-15 amino acids in length so that the resulting parent ions and transition ions fall within mass range of the triple quad mass spectrometer. Furthermore, optimal peptides result in amino acids sequences that are not readily prone to chemical modifications, such as those containing cysteines, and are not prone to missed enzymatic cleavage, such as those with a C-terminal proline followed by arginine or lysine. In the case of E protein serotyping assay, trypsin digestion resulted in the best peptide map. However, when evaluating the amino acid sequence of prM it was determined that GluC was the ideal enzyme when monitoring uncleaved vs. cleaved prM because trypsin digestion occurred in the exact location as furin cleavage. By designing two assays, one with GluC and one with trypsin, to evaluate relative degree of immature virus we are able to include the evaluation of pr that has already been cleaved with furin in the golgi but that somehow becomes associated with the viral particle during the exit from the cell.

By monitoring the ratio of the structural protein to one another in this multiplex assay to determine the relative degree of immature virus, the need for expensive labeled internal standards or time consuming standard curve evaluation was alleviated. Furthermore, given the specificity and the sensitivity of the MRM assays a single amino acid shift is detected. Therefore, this assay can also be used to determine the specific dengue serotype of the infection by monitoring multiple ions from the structural E protein; specifically one unique peptide from each of the different serotypes.

Briefly, the method involves a sample preparation which included an acetone precipitation to break down the lipid membrane of the virus, digestion of the protein into peptides with trypsin or GluC, depending on the assay, followed by mass spectral evaluation. The mass spectral analysis was done by targeting specific ions in both the first and second dimension for each of the unique peptides chosen from each of the structural proteins. Ions were targeted in both dimensions (MS and MS2) to ensure specificity of the assay. Each of the ions was optimized for both the fragmentor energy (energy used to ionize the parent ion (analyte/peptide) at the front end and reduce dimerization) and the collision energies (energy used to induce fragmentation of the parent ion into daughter ions/transitions) ensuring the highest level of sensitivity. The data was then analyzed to determine either the absolute quantity of the peptides/proteins in the sample if evaluated against a standard curve or the relative quantitation based on the ratio between the E protein, prM protein and the M protein.

The specific and unique peptides, transitions and related assay parameters are given in the following tables for dengue virus types 1-4.

TABLE 1

| | | TRANSITIONS | | | | |
|---|---|---|---|---|---|---|
| | | precursor ion | RETENTION | DWELL | FRAGMENTOR | COLLISION |
| | | [M + H]*-> | TIME | TIME | ENERGY | ENERGY |
| PROTEINS | PEPTIDES | product ion | (min) | (min) | (kV) | (kV) |
| E_protein_dengue 1 | LITANPIVTDK | 592.8->672.3 | 7.2 | 100 | 180 | 20 |
| | (SEQ ID NO.: 1) | 592.8->786.4 | | | | 24 |
| E_protein_dengue 2 | IPFEIMDLEK | 613.8->800.4 | 7.7 | 100 | 200 | 25 |
| | (SEQ ID NO.: 2) | 613.8->686.4 | | | | 20 |
| E_protein_dengue 3 | LITANPVVTK | 528.3->657.4 | 7.9 | 100 | 180 | 20 |
| | (SEQ ID NO.: 3) | 528.3->728.4 | | | | 20 |
| E_protein_dengue 4 | YEGTGAPCK | 548.3->404.3 | 7.5 | 100 | 200 | 20 |
| | (SEQ ID NO.: 4) | 548.3->491.2 | | | | 20 |
| E_protein_conserved_dengue_1-4 | EIAETQHGTIV | 733.2->795.2 | 9.3 | 100 | 180 | 18 |
| | IR | 733.2->1024.2 | | | | 25 |
| | (SEQ ID NO.: 5) | | | | | |

TABLE 2

| | | | Transitions | | | |
|---|---|---|---|---|---|---|
| | | | precursor ion | | | |
| | | | [M + H]*-> | dwell time | Fragmentor | collision |
| Proteins | Enzyme | Peptides | product ion | (min) | energy (kV) | energy (kV) |
| PrM_protein | GluC | KRSVALVPHVGMGLE | 531.6->723.5 | 40 | 180 | 10 |
| | | (SEQ ID NO.: 6) | 531.6->666.8 | | | 15 |
| Pr_protein | GluC | FHLTTRNGEPHMIVSRQE | 538.7->862.4 | 40 | 180 | 20 |
| | | (SEQ ID NO.: 7) | 538.7->731.5 | | | 17 |
| Pr_protein | typsin | SLLFK | 304.2->520.3 | 50 | 160 | 6.2 |
| | | (SEQ ID NO.: 8) | 304.2->407.3 | | | 6.2 |
| E_protein | GluC | HGSCVTTMAKNKPTLDFE | 675.3->611.3 | 40 | 180 | 30 |
| | | (SEQ ID NO.: 9) | 675.3->356.7 | | | 30 |
| E_protein | trypsin | EIAETQHGTIVIR | 733.9->1024.2 | 50 | 160 | 25 |
| | | (SEQ ID NO.: 10) | 733.9->658.3 | | | 20 |
| M_protein | GluC | SVALVPHVGMGLE | 654.8->938.5 | 40 | 180 | 20 |
| | | (SEQ ID NO.: 11) | 654.8->839.3 | | | 15 |
| M_protein | trypsin | IETWILR | 465.7->817.5 | 50 | 200 | 12 |
| | | (SEQ ID NO.: 12) | 465.7->688.5 | | | 8 |

What is claimed is:

1. A method for identifying a dengue virus serotype, the method comprising:
obtaining a sample comprising at least one dengue virus protein;
digesting the protein to produce peptides;
ionizing the peptides;
detecting a parent and associated fragment ion of the peptides; and
identifying the serotype based on results of the detecting step.

2. The method according to claim 1, further comprising diagnosing a dengue virus related disease based upon the serotype of the dengue virus.

3. The method according to claim 1, wherein the protein is an E protein.

4. The method according to claim 3, wherein the peptides of the E protein are at least one peptide selected from the group consisting of SEQ ID NOs.: 1-5 and 9-10.

5. The method according to claim 1, wherein the sample is a human tissue or body fluid.

6. The method according to claim 5, wherein the body fluid is blood.

7. A method for determining an amount of immature dengue virus particles in a sample, the method comprising:
obtaining a sample comprising dengue virus particles;
determining a ratio of structural proteins in the sample to one another; and
determining an amount of immature virus in the sample based upon the ratio.

8. The method according to claim 7, wherein the structural proteins are E, pr, and M.

9. The method according to claim 8, wherein determining a ratio comprises a mass spectrometry based multiple reaction monitoring assay.

10. The method according to claim 9, wherein peptides of the E protein comprising SEQ ID NOs. 1-5 and 9-10 are monitored.

11. The method according to claim 9, wherein peptides of the pr protein comprising SEQ ID NOs. 6-8 are monitored.

12. The method according to claim 9, wherein peptides of the M protein comprising SEQ ID NOs. 11-12 are monitored.

13. The method according to claim 7, wherein the sample is a human tissue or body fluid.

14. The method according to claim 13, wherein the body fluid is blood.

15. A method for determining an amount of immature dengue virus particles in a sample, the method comprising:
obtaining a sample comprising dengue virus particles;
obtaining an amount of structural proteins in the sample;
comparing the amounts to a standard curve; and
determining an amount of immature virus in the sample based upon results of the comparing step.

16. The method according to claim 15, wherein the structural proteins are E, pr, and M.

17. The method according to claim 15, wherein obtaining an amount of structural proteins in the sample comprises a mass spectrometry based multiple reaction monitoring assay.

18. The method according to claim 17, wherein peptides of the E protein comprising SEQ ID NOs. 1-5 and 9-10 are monitored.

19. The method according to claim 17, wherein peptides of the pr protein comprising SEQ ID NOs. 6-8 are monitored.

20. The method according to claim 17, wherein peptides of the M protein comprising SEQ ID NOs. 11-12 are monitored.

21. The method according to claim 15, wherein the sample is a human tissue or body fluid.

22. The method according to claim 21, wherein the body fluid is blood.

23. A composition comprising at least one peptide selected from the group consisting of SEQ ID NOs.: 1-12.

24. A method for identifying a dengue virus serotype, the method comprising:
obtaining a sample comprising at least one dengue virus protein;
digesting the protein to produce peptides;
conducting an assay to detect presence of any of SEQ ID NOs.: 1-4 in the sample;
identifying the serotype based the detected sequence.

25. The method according to claim 24, wherein the assay is a mass spectrometry based multiple reaction monitoring assay.

26. The method according to claim 24, wherein the sample is a human tissue or body fluid.

27. The method according to claim 26, wherein the body fluid is blood.


SEQUENCE LISTING (12 sequences)

SEQ ID NO: 1 - protein, 11 aa, Dengue virus type 1
LITANPIVTDK

SEQ ID NO: 2 - protein, 10 aa, Dengue virus type 2
IPFEIMDLEK

SEQ ID NO: 3 - protein, 10 aa, Dengue virus type 3
LITANPVVTK

SEQ ID NO: 4 - protein, 9 aa, Dengue virus type 4
YEGTGAPCK

SEQ ID NO: 5 - protein, 13 aa, Dengue virus
EIAETQHGTIVIR

SEQ ID NO: 6 - protein, 15 aa, Dengue virus
KRSVALVPHVGMGLE

SEQ ID NO: 7 - protein, 18 aa, Dengue virus
FHLTTRNGEPHMIVSRQE

SEQ ID NO: 8 - protein, 5 aa, Dengue virus
SLLFK

SEQ ID NO: 9 - protein, 18 aa, Dengue virus
HGSCVTTMAKNKPTLDFE

SEQ ID NO: 10 - protein, 13 aa, Dengue virus
EIAETQHGTIVIR

SEQ ID NO: 11 - protein, 13 aa, Dengue virus
SVALVPHVGMGLE

SEQ ID NO: 12 - protein, 7 aa, Dengue virus
IETWILR